(19) United States
(12) Patent Application Publication
(10) Pub. No.: US 2022/0058674 A1
(43) Pub. Date: Feb. 24, 2022

(54) SYSTEMS AND METHODS FOR PROVIDING SUBSIDIZED DATA CONNECTIVITY

(71) Applicant: Ahmad Fares, (US)

(72) Inventor: Ahmad Fares, Santa Clarita, CA (US)

(21) Appl. No.: 16/892,274

(22) Filed: Jun. 3, 2020

(51) Int. Cl. G06Q 30/02; H04W 48/02

(52) U.S. Cl. CPC G06Q 30/0206; G06Q 30/0239; H04W 48/02

(57) ABSTRACT

Systems and methods are disclosed for web and/or mobile applications that provide users with access to data connectivity in a communication and/or browsing platform. Such connectivity can be cellular (e.g., 3G/4G/5G/etc.) and/or Wi-Fi based and may be associated with an electronic subscriber module (whether physical such as a SIM card, or digital such as a soft SIM or eSIM) or another type of digital identity like a credit card. Based on the usage time and location, interaction, and/or ad types associated with the application, users are eligible to receive connectivity credit that may be limited (volume, location or time caps) or indefinite/unlimited.

### CROSS-REFERENCE TO RELATED APPLICATIONS

The present application claims the benefit of U.S. Patent Application No. 62/864,039, filed Jun. 20, 2019, the contents of which are hereby incorporated by reference in their entireties.

### FIELD OF THE INVENTION

The present invention is directed to systems and methods for an online service (e.g. communication and browsing application) that provides its users with access to subsidized data connectivity through cellular technologies (e.g., 3G, 4G, 5G, etc.) and/or other connectivity alternatives like Wi-Fi, which may be associated with an electronic subscriber identity module (SIM) such as a physical SIM card, a soft SIM, an embedded SIM (eSIM also referred to as embedded Universal Integrated Circuit Card “eUICC”) or an integrated SIM (iSIM also referred to as integrated Universal Integrated Circuit Card “iUICC).

### BACKGROUND OF THE INVENTION

Users of mobile and computing devices are exposed daily to numerous web and mobile apps with different formats of online ads. In most formats of consumer-focused internet applications, especially in communication or browsing applications, application providers typically provide the application for free and generate revenues from online ads they show from within their applications to their users, without concretely sharing any of such revenues/rewards with their users.

In some cases such as in mobile gaming, apps provide their players/users with points or credit but typically only towards playing/using the same game/app or another associated game/app, thereby making such rewards fairly restricted.

Separately, providing users with connectivity—in particular cellular data or cellular data roaming—can be relatively expensive. As a result, some users cannot afford such connectivity on a regular basis or while away from their home network, and thus stay disconnected most of the time or while traveling overseas. As another result, cellular networks remain underutilized. Indeed, the utmost majority of these networks operate worldwide at radio capacity utilization of less than 25%.

Such dis-connectivity problem also prevents many transactions (e.g. mobile banking, online shopping, ride sharing, etc.) from happening online as connectivity is a pre-requisite to such online transactions same like e-payment methods such as credit, debit and gift cards.

There is therefore a need for improved systems and methods for providing subsidized or sponsored data connectivity that can provide users with more diversified benefits related to ads and/or interactive/information-gathering surveys, such as improved or more cost efficient connectivity, data communication and/or internet-based browsing capabilities. Such connectivity benefits can be provided from online ads' revenue share and/or as sponsored connectivity from online merchants and service providers who would provide such complimentary connectivity to facilitate online transactions and engagement with their online offerings.

### SUMMARY OF THE INVENTION

The invention relates to systems and methods for providing subsidized data connectivity that can help users to save on their mobile bills and/or stay connected if they cannot afford expensive forms of connectivity such as local cellular data and/or international data roaming. The invention can take the form of a web or mobile application—including internet-based features like messaging (ephemeral or permanent, short message service or WebRTC-based), voice and/or video communication (VoIP), web/news/social browsing, and/or file sharing—that provides users preferably with a single super-app interface to different web services and on top provides connectivity rewards. Such rewards may be in the form of free or discounted cellular data access that may be based on the time spent using, or amount of interaction between, an associated application and different types of online advertisements (ads) or information gathering surveys. Such online ads are either associated with or built into the application interface, preferably consume none or only a small percentage of the provided connectivity reward, and can take different shapes and formats including display advertising (e.g., banners), interstitial ads, video ads, AR/VR immersive ads, search engine marketing and/or optimization, native advertising, affiliate marketing and any other type of online advertising or interactive/information-gathering survey. An associated application may provide its users with:
a single, user-friendly interface—instead of multiple (typically unused) apps—to different services, especially commonly used communication and browsing features, and
improved and more cost-efficient access to what is typically expensive forms of connectivity especially cellular data (local or international); this enables users who cannot afford cellular data on a regular basis—especially in remote/marginalized communities, developing countries or while traveling—to get connected at low or even no cost. For example, in the US, the Lifeline program provides eligible households that do not have broadband service at home (over 13 million users) with a monthly credit to access the internet, and the systems and methods described herein will help to mitigate this problem.

The invention also relates to systems and methods for providing subsidized connectivity that can help online businesses and service providers (such as online banking, shopping or travel service providers) to reach more customers by sponsoring connectivity (e.g. cellular data and/or international data roaming) to enable consumers to transact and/or interact with the service offerings of such online businesses. Such sponsored connectivity can be provided and distributed in digital formats such as QR codes, a web link or an application and can activate a subscriber module (like eSIM, iSIM or soft SIM). The provided connectivity service can take different forms including unrestricted access to the internet or restricted internet access to the online service provider's web portal or mobile application; through such access the customer is able to interact and transact with the online service provider. Such mutually beneficial arrangement creates a new market for online businesses with “disconnected” customers who could not afford connectivity (e.g. cellular data and/or international data roaming) and enables customers to access online services without worrying about the associated connectivity costs.

### BRIEF DESCRIPTION OF THE DRAWINGS

FIG. 1 is a block diagram illustrating the different factors that can affect the provided connectivity credits and rewards;

FIG. 2 is a flow diagram illustrating a sample sign-up process for the user to go through to start receiving connectivity credits and rewards;

FIG. 3 is a diagram of an exemplary application (for browsing & communication) with one particular type of online advertisement;

FIG. 4 is a flow diagram illustrating how sponsored connectivity can enable users to access online services.

### DESCRIPTION OF EMBODIMENTS OF THE INVENTION

Described herein are systems and methods to reward users with connectivity credit (e.g., cellular data, Wi-Fi connectivity, etc.) for utilizing a web/mobile application which includes communication and/or browsing features with associated online advertisements (ads) and/or interactive/information-gathering surveys of different formats.

The systems and methods described herein provide users with free (or discounted) data (e.g., internet-based) communication and/or browsing features, in addition to cost-efficient (e.g., free or discounted) data connectivity for devices used with associated applications including smartphones, wearables, laptops, pads, AR/VR headsets, gaming devices, or any electronic device with display features. Such “sponsored”, wireless data connectivity can be cellular and/or Wi-Fi based, enabling application users to freely access the internet and enjoy not only the communication and/or browsing features of the application, but also other returns and benefits.

Specifically, by awarding users connectivity credits for viewing/interacting with the ads and/or interactive/information-gathering surveys, the invention enables users to save on and possibly eliminate their wireless connectivity expenditure such as monthly cellular bills, paid premium Wi-Fi, and/or data roaming charges while abroad. In certain cases, and depending on their daily usage of the application, users may obtain enough connectivity credit in the form of cellular data. For example, users may be provided with discounted or free 1 gigabyte of cellular data for a given week in a given country. As another example, users may be provided with up to 2 or 4 gigabytes in a given month to enable them to completely avoid their monthly cellular data bills.

In certain embodiments, the systems and methods described herein are able to communicate through a limited purpose link for the purpose of serving ads/surveys to the user, while allowing the user to accumulate connectivity credit for communicating over a general purpose data link. Such connectivity credit can be also used for other devices if a user device includes, for example, a personal hotspot option or similar shared connectivity feature.

In other embodiments, the systems and methods described herein enable users of smart devices to get sponsored connectivity (e.g. cellular data or data roaming) which allow them to interact and transact with online service providers (e.g providers of financial, entertainment or transport services). Online service providers can be the sponsors of such connectivity and can benefit from reaching out to new customer base. The sponsored connectivity can be restricted to accessing the online interfaces (e.g. website or mobile application) of the sponsoring service provider only, or it can be unrestricted wireless broadband access. The distribution of such connectivity can be either digital (e.g. through QR codes, activation links or apps) or physical (cards) to enable the activation of subscriber modules such as eSIM, iSIM or SIM cards.

The invention can prove beneficial on both the user and the network end as follows:
from a user perspective, users who cannot afford cellular data connectivity on a regular basis or while away from their home network can now utilize associated applications to acquire and accumulate connectivity credit that gives them generic access to data-based communication (e.g., internet browsing, web-based communication, VoIP, etc.), and
from the cellular networks' perspective, the invention can dramatically increase the utilization of such network.

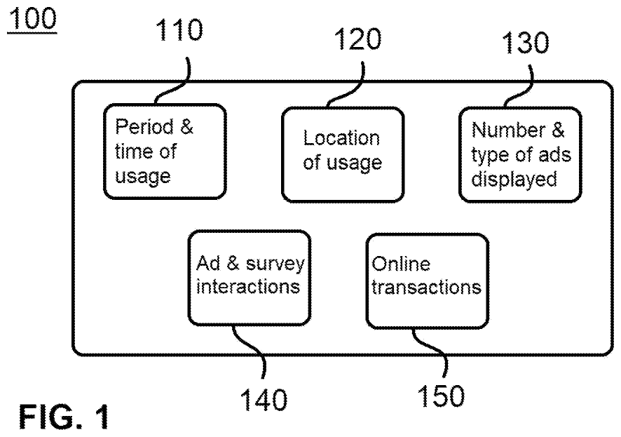

In general, for every user, an initial credit balance may be established upon signing up with a unique e-mail, phone number or other types of digital identity that (preferably uniquely) identifies the user. This initial credit (e.g., free 1 GB of data) will enable the user to get started with free internet access. Once the user starts accessing associated application(s), and based on a combination of different metrics shown in FIG. 1, the user may be provided with “connectivity” credit that accumulates and translates into regular connectivity rewards with or without capacity caps and/or time caps, such as free 1 gigabyte of cellular data for a week or a month and/or unlimited free Wi-Fi, in different locations/countries.

FIG. 1 includes examples of the metrics and steps 100 that can affect the connectivity credit that user would be entitled to receive and accumulate. Metric 110 comprises the usage time of the application (e.g., minutes or hours in a given day, week or month). Metric 120 includes the location (e.g. city or country) of usage. Metric 130 comprises the number and type of ads displayed to the user. Metric 140 comprises the number or quality of interactions made with ad content or interactive/information-gathering surveys (e.g., participation or answer to questions posed). Finally Step 150 includes online transactions and/or service providers that just provide sponsored connectivity credit to facilitate transacting and/or interacting with the user receiving the credit.

The locations or countries where the connectivity credit can be consumed can be the user's city or country of residence or other countries that can be pre-selected by the user (e.g., to stay connected while traveling abroad).

Users may also transfer their connectivity credits to other users of associated applications and may be eligible for additional connectivity credit for referring new users (e.g., friends and family). Also, users may opt to use associated applications without any ads. In such cases, users may not be eligible for any connectivity credit.

The original mechanism of rewarding consumer time/usage with connectivity credit described herein—can be also distributed to web/mobile applications through an API (application programming interface) or SDK (software development kit) to enable users of other web/mobile applications (e.g., travel-related or online shopping/banking applications) to get connectivity credit for using such applications for enhanced user engagement, loyalty and further online business.

In the current era of “hyper-connectivity”, consumers' time and attention online is of value, and the innovative systems and methods of the present invention provide users with a single interface with a built-in reward mechanism for providing more efficient and affordable data connectivity that for example enables wider access of the internet.

For example, the user may be identified by e-mail, mobile number, credit card or other digital identity to be able to sign-up for the service, and should have an electronic device (including one or more smartphones, wearables, laptops, pads, AR/VR headsets, gaming devices, or any electronic device with display features) that support cellular data connectivity through a physical SIM card, a soft SIM or an embedded SIM (eSIM) or another type of data connectivity (e.g., Wi-Fi).

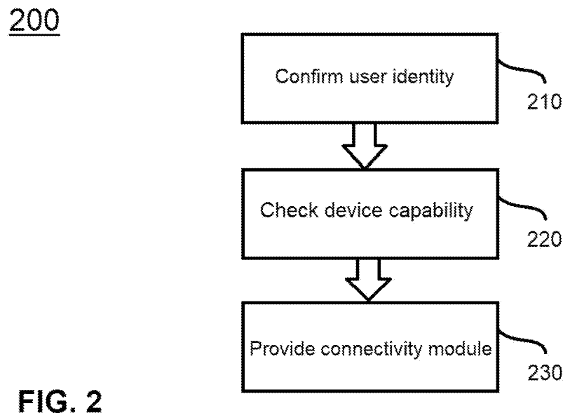

FIG. 2 illustrates an exemplary method 200 for a sign-up process. In step 210 the user is required to confirm her/his identity (e.g. through email or text message). In step 220, the user's device connectivity capability (e.g., if it is eSIM enabled or not) is checked whether via manual selection or automatic process/applet; one method can be for an applet to check the device's International Mobile Equipment Identity “IMEI” and automatically deduce if the device supports eSIM or iSIM. Finally in step 230, the user receives from a provider an activated subscriber module —whether physical such as SIM card or digital such as soft SIM or eSIM—to be installed on the device to be connected. In case of a released eSIM, the delivery can be online through a QR code that the user can scan with the device camera to automatically download and install the eSIM.

Thereafter, the user may receive an optional sign-up credit. To illustrate further with an example, when the user has an eSIM-enabled device, during sign-up an application may automatically detect the device model and its eSIM capabilities and then require the user to either scan an eSIM QR code or use a web link or an app to download an eSIM to receive the initial sign-up credit (and/or future credits). In general, the subscriber module's (whether a SIM card, an eSIM or an iSIM) role is to facilitate connectivity to the cellular and/or Wi-Fi network(s) provided by the associated application, and all connectivity credit will be associated with such subscriber module (or its associated digital identity).

A variety of features related to the user data access and/or usage of the internet may be included in an associated application. Two basic features that may be included are communication and browsing features, but such features may be expanded to include online gaming, banking or social networking features. Communication features of associated applications may comprise secure and encrypted (end-to-end) chats and/or calls, and preferably communication content of the application shall not be accessible to the application provider or its advertisers. To elaborate more, the communication feature may include a combination of one or all of the following options:
secure web messaging (whether ephemeral or permanent) among application users;
an option to “listen” to text messages (e.g., an application may audibly “read” a received text to a user) and/or to dictate text to an application for sending, e.g., in order to preserve data credit as sending text data consumes significantly less data than voice data (a typical text message/SMS is 100-200 bytes in size while a 3 second voice message conveying the same message can consume about 20× more data);
video and/or voice calling among two or more application users;
file, photo, video, music or other digital content sharing among application users;
texting (e.g., short message service) from application users to regular mobile users that have mobile services without necessarily having the same application;
voice and/or video calling from application users to regular mobile users with mobile numbers; and/or
voice, text and/or video calling from application users to users of other over-the-top (OTT) applications, whenever compatible.

Secondly, any browsing features of associated applications may include web browsing, enabling different kinds of internet and/or content surfing like news and/or social media. And whenever compatible, such browsing may cover content of other web or mobile applications of interest to the user and/or already installed in the user's device. An application-based browser may include any of the following sub-features:
a “read” option to audibly pronounce textual content to the user, which is beneficial for small screens and/or for users with vision/reading limitations; such a “read” option can be associated with one or more voice commands that the user can provide in order to navigate internet content or other internet-based applications;
an option to enable users to share with other users “pointer” links to a specific content/section of a web page instead of general web links of the whole page. For example, currently a user may take a screen shot of a web page section to share only that section of the page instead of sharing a web link to the full page. Typically, such practice is inefficient as photos (which are generally unsearchable, consume more data to share, etc.) are not optimal medium to share web content. Accordingly, a web pointer can be an extended web link that directly points to a section of a web page instead of the whole page.

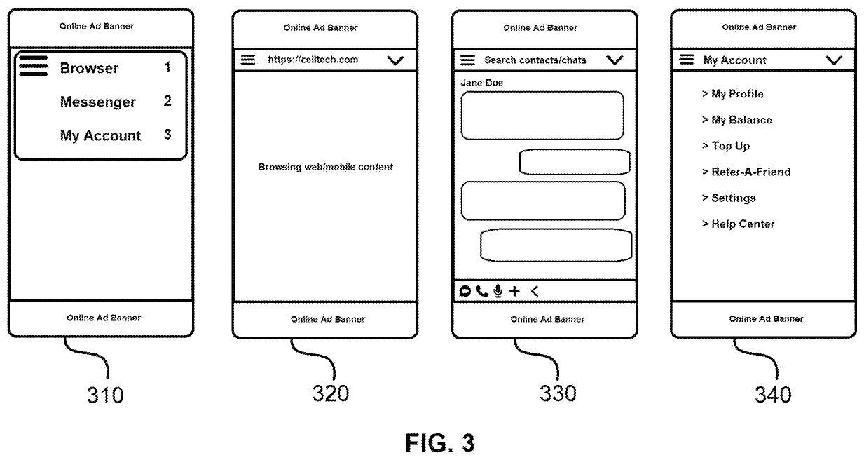

FIG. 3 includes an exemplary embodiment of an application associated with systems and methods for providing data connectivity in a communication and browsing environment with one particular type of online advertisement. In screen 310, the main menu of such application is shown including its main features. In screen 320, the browsing feature is shown with one type of online ads (e.g. image or video banners) at the top and bottom of the app screen. In screen 330, the communications features are shown with similar type of ads. Finally, in screen 340, the user account options are shown, including additional options of how the user can obtain extra connectivity credits (e.g. “Refer-A-Friend” option).

One exemplary method for implementing an associated application is to enable ads within digital content consumed by the user (such as music or videos) to enable the user to get connectivity credit.

In certain embodiments, an associated application provides a unified/integrated browsing interface from which users can:
browse the web (including news websites, search engines, ecommerce sites, etc.),
browse social media apps' content that can be added and/or opened from within the application (e.g., using techniques similar to web bookmarks/favorites), and/or
browse entertainment apps' content (e.g., video, music, gaming) and any other related web/mobile content.

In other embodiments, application may provide a single/integrated communication interface from which its users can send messages (e.g., text/voice/video or other digital files/content) to:
other users of the same application;
an e-mail address;
a mobile number; and/or
other users of other communication applications.
   Such embodiments will not only simplify and consolidate the way users access the data-based services and apps, but also enable such users to receive rewards in the form of data connectivity. For example, data connectivity can be awarded in the form of a fixed data amount (e.g., a megabyte, gigabyte, etc.), a data-usage period (e.g., minutes, hour, week, month), usage location (e.g., roaming, local, generally or a particular network/locale) and/or a combination.

In other embodiments, an associated application receives data providing connectivity awards (e.g., ads/surveys) via a limited purpose/restricted communication link with the network operator. Discussion of the use of limited purpose links to provision cellular connectivity via transmission of (e.g., authentication information) is discussed in application Ser. No. 15/881,580. For example, in certain embodiments, a limited purpose link may be used to serve connectivity reward data in addition to/instead of communicating authentication information with the mobile device. As another example, a limited purpose link (e.g., a port, IP address, etc.) may be used to serve/provide un-metered connectivity reward data from the network. Data from other links (e.g., a port, IP address, etc.) may be metered by the network. Such metered connectivity may be refilled via the connectivity awards provided over the un-metered link or via other options (e.g., purchase).

In case the user requires further data connectivity exceeding an associated credit balance (e.g., “My Balance”), the user may use the Top-up option included in step 340 FIG. 3 to increase the associated balance by either buying more credit from a provider (e.g., an application provider) or by other methods such as watching video ads or going through certain surveys. Another option to increase the user balance can be through the “Refer-A-Friend” route also included in the sample embodiment's step 340 in FIG. 3.

In other embodiments, the user is provided with an option to select an associated speed for the remaining data connection credit (e.g. by selecting from three options, such as: full-speed, basic-speed, economy, to enable longer connectivity period or slower/faster data connection depending on the user preferences). For example, certain users within certain age groups may not consume much video content online and thus may not need full-speed connectivity while other age groups may prefer full speed access, especially for video-based applications. While this option may be selected from within an application, it may not necessarily be enforced by the application itself but transmitted to the backend of the providing network to be enforced from the source network end. In certain cases the user can selectively limit such speed selection, for example only to video-based content or to the general data connection as a whole.

Using the principles described herein, a usage mechanism (e.g., tapping, browsing or typing pattern analysis) may be utilized to confirm the user is a real human instead of a robot, bot or an Al-enabled tool. If the user appears not to be a human user, an associated application may automatically blacklist such user (e.g., using their device International Mobile Equipment Identity “IMEI” or eSIM identifier “EID”) and stop providing connectivity and/or cancel the previously provided credit for such kind of machine-based usage. And upon user consent, the browsing content and/or patterns might be utilized (e.g., in the form of metadata) to improve the user experience within an application and its associated features and ads.

In certain embodiments, an associated application may include an applet, background service, web link or script to detect that the associated device has eSIM or iSIM capability. In cases where eSIM compatibility/capability is detected, eSIM based connectivity may be offered as discussed above. In certain other cases, the user may be questioned as to whether they have a compatible device (e.g., by selecting from a list of known devices). In other cases, where the user is unsure about their device (or the device is different from the one being used for sign-up), a link may be sent and opened on the desired device to check and confirm compatibility. Following confirmation of device compatibility, the user may be presented with the option to get an eSIM as her/his subscriber module to be associated with the application and its data-based connectivity rewards.

Another exemplary method for implementing subsidized data connectivity is to enable online service providers to provide users with a web link, an app or a QR code that allows users to get free connectivity and accordingly interact and transact with the online offerings of the service providers. An example can be an international ride sharing company giving a user free cellular data for a country where the user is traveling to enable such user to use the ride sharing service/application upon arrival. This creates new business for the online service provider while saving on cellular data and data roaming costs for the user who may not afford such service whether locally or while traveling abroad.

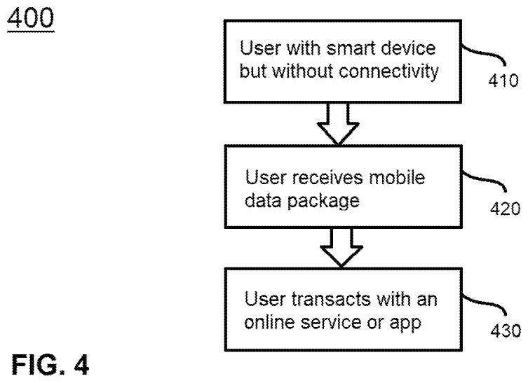

FIG. 4 illustrated an exemplary method 400 for enabling a “disconnected” user to be able to get subsidized or sponsored connectivity (e.g. mobile data package) to enable interaction/transaction with the online service provider sponsoring such connectivity. In step 410 a user may have a smart device (e.g. eSIM-enabled smartphone) but without connectivity at a given time and/or location. In step 420 the user receives from a service provider a sponsored connectivity service (e.g. mobile data package of 0.2 GB) that can be accessed and activated online (e.g. via a web link, QR code or mobile app while being temporarily connected) or by mail (e.g. by receiving a SIM card and inserting it in a smart device). In step 430, the user who is now connected can transact with the service provider (e.g. via website or app) sponsoring the connectivity. Such format of sponsored connectivity can be restricted (i.e. allowing internet access only to the sponsoring service provider's website/app) or unrestricted (i.e. allowing general wireless internet access).

The features and methods described herein can be distributed to applications through an application programming interface (API) for web-based apps or through a software development kit (SDK) for mobile-based apps. One example is a travel application (e.g., airline or hotel web/mobile application) that requires and provides connectivity to its customers when they are abroad to possibly offer other travel services (like upgrade options, re-booking services, online shopping or other relevant products/services) and improve their user engagement and loyalty.

While the foregoing describes certain use cases (e.g., in connection with communication and browsing features), it will be understood that other use cases are contemplated and possible (e.g., obtaining intermittent connectivity services for a particular device or machine within a local network or any other network) without departing from the spirit of the invention. Certain exemplary embodiments of the invention are illustrated and discussed herein, with the understanding that other variations are possible.

While there have been shown and described various novel features of the invention as applied to particular embodiments thereof, it will be understood that various omissions and substitutions and changes in the form and details of the systems and methods described and illustrated, may be made by those skilled in the art without departing from the spirit of the invention. Those skilled in the art will recognize, based on the above disclosure and an understanding therefrom of the teachings of the invention, that the particular hardware and software processes that are parts of the foregoing descriptions, and the general functionality provided by and incorporated therein, may vary in different embodiments of the invention. Accordingly, the particular components and processes shown and/or discussed above are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation.

What claimed is:

1. A mobile system for provisioning subsidized data connectivity for one or more smart devices that employ a subscriber module, the system comprising:
a processor configured to execute instructions for an application with browsing and communication capabilities allowing a user to:
browse the internet or feeds from other apps, as a single interface to the worldwide web;
share different types of digital files and content including extended web links that can point to a specific section within a web page;
communicate with other users and non-users of the application using text, voice, and video;
access different formats of online advertisements and/or surveys while using the application to receive local and/or international connectivity credits or rewards based on metrics, wherein the metrics comprise period or time of usage, location of usage, or type and number of advertisements.

2. The mobile system of claim 1 wherein the system is configured to be distributed through an API and/or SDK to allow other online service providers and applications to integrate such system in their online offerings and reward their end users with subsidized connectivity.

3. The method of claim 2 wherein the distribution and activation of said subsidized connectivity to the end users is done online through digital alternatives such as QR codes, apps, and/or web links.

4. The method of claim 2 wherein the distribution and activation of said subsidized connectivity to the end users is done offline such as by mailing SIM cards.

5. The mobile system of claim 1 wherein the connectivity credits or rewards comprise discounted or free wireless broadband whether restricted or unrestricted cellular and/or Wi-Fi service.

6. The mobile system of claim 1 wherein the subscriber module is an embedded Universal Integrated Circuit Card.

7. The mobile system of claim 1 wherein the subscriber module is an integrated Universal Integrated Circuit Card.

8. The mobile system of claim 1 wherein the subscriber module is a SIM card.

9. The mobile system of claim 1 wherein the subscriber module is a soft SIM included in the one or more smart devices as a software feature.

10. A method for allowing online businesses to sponsor and share restricted or unrestricted connectivity to enable subscribers to use smart devices that employ a subscriber module to interact and transact with the sponsoring business online whether through its mobile app and/or web portal, the method comprising:
An online business partnering and/or integrating with a network carrier or service provider platform that offers mobile connectivity services;
The online business sponsoring local and/or international connectivity service and offering it at a discount or for free to its existing or new, local or global users;
In return the users benefiting from the sponsored connectivity are expected to interact and/or transact with the online business offerings.

11. The method of claim 10 wherein the system is configured to be distributed through an API and/or SDK to allow other online service providers and applications to integrate such system in their online offerings and reward their end users with subsidized connectivity.

12. The method of claim 11 wherein the distribution and activation of said subsidized connectivity to the end users is done online through digital alternatives such as OR codes, apps, and/or web links.

13. The method of claim 11 wherein the distribution and activation of said subsidized connectivity to the end users is done offline such as by mailing SIM cards.

14. The method of claim 10 wherein the subsidized connectivity comprises discounted or free wireless broadband whether restricted or unrestricted cellular and/or Wi-Fi service.

15. The method of claim 10 wherein the subscriber module is an embedded Universal Integrated Circuit Card.

16. The method of claim 10 wherein the subscriber module is an integrated Universal Integrated Circuit Card.

17. The method of claim 10 wherein the subscriber module is a SIM card.

18. The method of claim 10 wherein the subscriber module is a soft SIM included in the one or more smart devices as a software feature.
